(19) United States
(12) Patent Application Publication
(10) Pub. No.: US 2024/0327572 A1
(43) Pub. Date: Oct. 3, 2024

(54) CURABLE RESIN COMPOSITION, VARNISH, PREPREG, AND CURED PRODUCT

(71) Applicant: HONSHU CHEMICAL INDUSTRY CO., LTD., Chuo-ku, Tokyo (JP)

(72) Inventors: Akihito NASU, Wakayama-shi (JP); Takeru YOSHII, Wakayama-shi (JP); Ryota IMAI, Wakayama-shi (JP); Kentaro WATANABE, Chuo-ku, Tokyo (JP)

(21) Appl. No.: 18/580,119

(22) PCT Filed: Aug. 9, 2022
(86) PCT No.: PCT/JP2022/030353

§ 371 Date: Jan. 17, 2024

(30) Foreign Application Priority Data
Aug. 23, 2021 (JP) 2021-135314

(51) Int. Cl. C08G 65/48; C08G 65/44; C08J 5/24

(52) U.S. Cl. CPC C08G 65/485; C08G 65/44; C08J 5/249; C08J 2371/12

(57) ABSTRACT

A curable resin composition for obtaining a cured product having improved heat resistance contains a component (A), which is a polyphenylene ether resin, in an amount of 100 parts by weight, and a component (B), which is a diallyl ether compound represented by general formula (1), in an amount of 0.1 to 4.9 parts by weight:

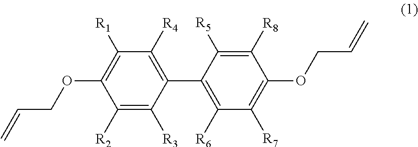

wherein R₁ to R₈ each independently represent a hydrogen atom or a linear or branched alkyl group having 1 to 5 carbon atoms.

### TECHNICAL FIELD

The present invention relates to a curable resin composition and prepreg for obtaining a cured product having improved heat resistance.

### BACKGROUND ART

Polyphenylene ether (PPE) has a low dielectric constant and a low dielectric loss tangent and thus is known to be suitable as a material for an electronic device such as a printed wiring board. For example, as a substrate material for a printed wiring board, properties such as flame retardance and heat resistance have also been required.

Polyphenylene ether resins are classified as thermoplastic resins and are typically used in combination with curing agents. Triallyl isocyanurate, which is a general-purpose curing agent, has a low melt temperature, and thus the curing agent volatilizes during thermal curing, so that curing performance equivalent to the amount added cannot be provided, and another problem of contamination of a production apparatus is also expected to arise.

To overcome these problems, PTL 1 discloses that diallyl ether compounds having a biphenyl group, such as 2,2′,3,3′,5,5′-hexamethyl-4,4′-bis(2-propen-1-yloxy)-1,1′-biphenyl and 3,3′-dimethyl-4,4′-bis(2-propen-1-yloxy)-1,1′-biphenyl, are less volatile during the process of forming a prepreg because the compounds themselves have higher 5% weight loss temperatures than triallyl isocyanurate, which is a conventional general-purpose curing agent.

In general, to produce a sufficiently crosslinked cured product of a polyphenylene ether resin, a large amount of curing agent is used. Unfortunately, however, when a curing agent that undergoes a great weight loss at high temperature, such as triallyl isocyanurate, is used in a large amount, the problem of apparatus contamination due to volatilized curing agent can arise as described above, whereas when the curing agent is used in a reduced amount, crosslinked portions for resin curing are not formed much, besides volatilization of the curing agent further reduces participation in crosslink formation, so that the resin cannot be sufficiently cured, and a cured product having desired characteristics cannot be obtained.

It has been revealed for the first time in EXAMPLES described later that when triallyl isocyanurate is used as a curing agent for polyphenylene ether, the smaller the amount of triallyl isocyanurate used, the lower the heat resistance of a resulting cured product, as demonstrated by Comparative Examples in EXAMPLES described later.

### CITATION LIST

### Patent Literature

PTL 1: International Publication No. 2020/256045

### SUMMARY OF INVENTION

### Technical Problem

An object of the present invention is to provide a curable resin composition and prepreg for obtaining a cured product having improved heat resistance.

### Solution to Problem

To achieve the above object, the present inventors have conducted intensive studies and found that a curable resin composition in which a diallyl ether compound having a biphenyl skeleton represented by general formula (1) below is used as a curing agent for curing of polyphenylene ether, the amount of the diallyl ether compound used being smaller than the amount of a typical curing agent used, can provide a cured product having improved heat resistance, thereby completing the invention.

The present invention is as follows.
1. A curable resin composition containing a component (A) below in an amount of 100 parts by weight and a component (B) below in an amount of 0.1 to 4.9 parts by weight.
   (A): a polyphenylene ether resin
   (B): a diallyl ether compound represented by general formula (1) below

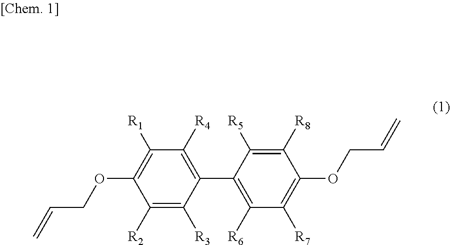

(In the formula, R₁ to R₈ each independently represent a hydrogen atom or a linear or branched alkyl group having 1 to 5 carbon atoms.)
2. The curable resin composition according to 1., in which the component (B) is at least one selected from 4,4′-bis(2-propen-1-yloxy)-1,1′-biphenyl, 3,3′-dimethyl-4,4′-bis(2-propen-1-yloxy)-1,1′-biphenyl, 3,3′,5,5′-tetramethyl-4,4′-bis(2-propen-1-yloxy)-1,1′-biphenyl, and 2,2′,3,3′,5,5′-hexamethyl-4,4′-bis(2-propen-1-yloxy)-1,1′-biphenyl.
3. The curable resin composition according to 1., containing a component (C) below in an amount of 0.05 to 1.0 parts by weight.
   (C): a reaction initiator
4. The curable resin composition according to 3., in which the component (C) is an organic peroxide.
5. The curable resin composition according to 4., in which the component (B) is at least one selected from 4,4′-bis(2-propen-1-yloxy)-1,1′-biphenyl, 3,3′-dimethyl-4,4′-bis(2-propen-1-yloxy)-1,1′-biphenyl, 3,3′,5,5′-tetramethyl-4,4′-bis(2-propen-1-yloxy)-1,1′-biphenyl, and 2,2′,3,3′,5,5′-hexamethyl-4,4′-bis(2-propen-1-yloxy)-1,1′-biphenyl.
6. A cured product obtained by curing the curable resin composition according to 1. or 3.
7. The curable resin composition according to 1. or 3., further containing a component (D) below.
   (D): a filler
8. A cured product obtained by curing the curable resin composition according to 7.
9. A varnish containing the curable resin composition according to 1. or 3. and a component (E) below.
   (E): a solvent
10. A prepreg containing the varnish according to 9. and a component (F) below.
   (F): a reinforcing fiber
11. A cured product obtained by curing the prepreg according to 10.

### Advantageous Effects of Invention

The curable resin composition according to the present invention, in which a diallyl ether compound having a biphenyl skeleton represented by general formula (1) below is used in a specific amount as a curing agent for curing of polyphenylene ether, can provide a cured product having excellent physical properties although the amount of the diallyl ether compound used is smaller than the amount of a typical curing agent used, and thus can achieve a significant reduction in the cost of the curing agent in the production of a processed product using a polyphenylene ether resin, which is industrially very useful. Furthermore, the problem of apparatus contamination due to volatilization of the curing agent can be reduced, which is very advantageous also in terms of yield and production efficiency.

### DESCRIPTION OF EMBODIMENTS

### <Component (A)>

A curable resin composition according to the present invention contains a polyphenylene ether resin as a component (A), and any polyphenylene ether resin can be used.

Specific examples of such a polyphenylene ether resin include poly(2,6-dimethyl-1,4-phenylene ether), poly(2-methyl-6-ethyl-1,4-phenylene ether), poly(2-methyl-6-phenyl-1,4-phenylene ether), poly(2,6-dichloro-1,4-phenylene ether), a copolymer of 2,6-dimethylphenol and another phenol (e.g., 2,3,6-trimethylphenol or 2-methyl-6-butylphenol), a polyphenylene ether copolymer obtained by coupling 2,6-dimethylphenol with a biphenol, a bisphenol, or a trisphenol, and a polyphenylene ether copolymer obtained by coupling 2,6-dimethylphenol and another phenol with a biphenol, a bisphenol, or a trisphenol.

A polyphenylene ether obtained by modifying a terminal hydroxy group of a polyphenylene ether resin with a functional group having an unsaturated double bond, such as allyl ether, acryloyl, methacryloyl, or vinyl ether, may also be used.

### <Component (B)>

The curable resin composition according to the present invention contains a diallyl ether compound represented by general formula (1) below as a component (B).

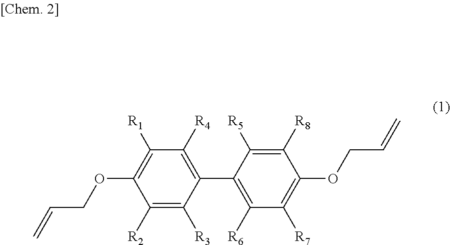

(In the formula, R₁ to R₈ each independently represent a hydrogen atom or a linear or branched alkyl group having 1 to 5 carbon atoms.)

R₁ to R₈ in general formula (1) above are preferably each independently a hydrogen atom or a linear or branched alkyl group having 1 to 4 carbon atoms, more preferably each independently a hydrogen atom or a methyl group. Still more preferably, R₃, R₄, R₅, and R₆ are hydrogen atoms and R₁, R₂, R₇, and R₈ are methyl groups, or R₄ and R₅ are hydrogen atoms and R₁, R₂, R₃, R₆, R₇, and R₅ are methyl groups. Particularly preferably, R₄ and R₅ are hydrogen atoms and R₁, R₂, R₃, R₆, R₇, and R₈ are methyl groups.

Examples of the diallyl ether compound represented by general formula (1) include 4,4′-bis(2-propen-1-yloxy)-1,1′-biphenyl, 3,3′-dimethyl-4,4′-bis(2-propen-1-yloxy)-1,1′-biphenyl, 3,3′-diethyl-4,4′-bis(2-propen-1-yloxy)-1,1′-biphenyl, 3,3′,5,5′-tetramethyl-4,4′-bis(2-propen-1-yloxy)-1,1′-biphenyl, 2,2′,3,3′,5,5′-hexamethyl-4,4′-bis(2-propen-1-yloxy)-1,1′-biphenyl, 4,4′-bis(2-propen-1-yloxy)-3,3′,5,5′-tetra-t-butyl-1,1′-biphenyl, and 4,4′-bis(2-propen-1-yloxy)-3,3′-di-t-butyl-1,1′-biphenyl.

Of these, 4,4′-bis(2-propen-1-yloxy)-1,1′-biphenyl, 3,3′-dimethyl-4,4′-bis(2-propen-1-yloxy)-1,1′-biphenyl, 3,3′,5,5′-tetramethyl-4,4′-bis(2-propen-1-yloxy)-1,1′-biphenyl, or 2,2′,3,3′,5,5′-hexamethyl-4,4′-bis(2-propen-1-yloxy)-1,1′-biphenyl is preferred, 3,3′-dimethyl-4,4′-bis(2-propen-1-yloxy)-1,1′-biphenyl, 3,3′,5,5′-tetramethyl-4,4′-bis(2-propen-1-yloxy)-1,1′-biphenyl, or 2,2′,3,3′,5,5′-hexamethyl-4,4′-bis(2-propen-1-yloxy)-1,1′-biphenyl is more preferred, 3,3′,5,5′-tetramethyl-4,4′-bis(2-propen-1-yloxy)-1,1′-biphenyl or 2,2′,3,3′,5,5′-hexamethyl-4,4′-bis(2-propen-1-yloxy)-1,1′-biphenyl is still more preferred, and 2,2′,3,3′,5,5′-hexamethyl-4,4′-bis(2-propen-1-yloxy)-1,1′-biphenyl is particularly preferred.

Of the diallyl ether compounds represented by general formula (1) as the component (B), one compound may be used, or two or more compounds may be used in combination, but it is preferable to use one compound.

The curable resin composition according to the present invention contains the diallyl ether compound represented by general formula (1) as the component (B) in an amount of 0.1 to 4.9 parts by weight relative to 100 parts by weight of the component (A).

The content of the component (B) is preferably in the range of 0.5 to 4.9 parts by weight, more preferably in the range of 0.8 to 4.9 parts by weight, still more preferably in the range of 0.9 to 4.2 parts by weight, particularly preferably in the range of 1.0 to 2.5 parts by weight, relative to 100 parts by weight of the component (A).

The curable resin composition according to the present invention can provide a cured product having excellent physical properties although the amount of the component (B) used is smaller than the amount of a typical curing agent used. In addition, in a resin composition containing a polyphenylene ether resin, the content ratio of the polyphenylene ether resin whose dielectric constant and dielectric loss tangent are low can be increased, and thus when the resin composition is used as, for example, a substrate material for a printed wiring board, it is expected that a printed wiring board having excellent electrical properties can be obtained.

### <Component (C)>

The curable resin composition according to the present invention preferably contains a reaction initiator as a component (C) in addition to the component (A) and the component (B). The component (C) is added to accelerate the crosslinking reaction of the curable resin composition containing the component (A) and the component (B).

The component (C) is not particularly limited as long as it accelerates the crosslinking reaction, and examples include ionic catalysts such as imidazoles, tertiary amines, quaternary ammonium salts, boron trifluoride amine complexes, organophosphines, and organophosphonium salts; and radical polymerization initiators such as organic peroxides, hydroperoxide, and azoisobutyronitrile. Of these, organic peroxides are preferably used.

Examples of organic peroxides include aliphatic organic peroxides such as di-t-butyl peroxide, dilauroyl peroxide, 2,5-dimethyl-2,5-di(t-butylperoxy) hexane, 2,2-bis(t-butylperoxy) butane, 2,2-bis(t-butylperoxy) octane, 2,5-dimethyl-2,5-bis(t-butylperoxy) hexyne, and di-n-propyl peroxydicarbonate; and aromatic organic peroxides including an aromatic ring such as dibenzoyl peroxide, dicumyl peroxide, t-butyl peroxybenzoate, t-amyl peroxybenzoate, t-butylcumyl peroxide, bis(1-t-butylperoxy-1-methylethyl)benzene, 2-phenyl-2-[(2-phenylpropan-2-yl) peroxy]propane, α,α′-di(t-butylperoxy)diisopropylbenzene, α,α′-bis(t-butylperoxy-m-isopropyl)benzene, and di-t-butylperoxy isophthalate. Of these, aromatic organic peroxides are preferably used, dicumyl peroxide, t-butylcumyl peroxide, bis(1-t-butylperoxy-1-methylethyl)benzene, and 2-phenyl-2-[(2-phenylpropan-2-yl) peroxy]propane are more preferred, and 2-phenyl-2-[(2-phenylpropan-2-yl) peroxy]propane is particularly preferred.

The curable resin composition according to the present invention contains the component (C) preferably in an amount of 0.05 to 1.0 parts by weight, more preferably in an amount of 0.15 to 0.9 parts by weight, still more preferably in an amount of 0.3 to 0.8 parts by weight, particularly preferably in an amount of 0.35 to 0.7 parts by weight.

One component (C) may be used alone, or two or more components (C) may be used in combination.

### <Component (D)>

The curable resin composition according to the present invention preferably contains a filler as a component (D) in addition to the component (A) and the component (B).

The component (D) is preferably contained in an amount of 10 to 150 parts by weight, more preferably contained in an amount of 10 to 100 parts by weight, relative to 100 parts by weight of the curable resin composition.

The component (D) is not particularly limited as long as it is a filler commonly used in a curable resin composition. For example, inorganic fillers such as silicon oxide, aluminum oxide, magnesium oxide, boron nitride, aluminum nitride, silicon nitride, silicon carbide, and hexagonal boron nitride can be used as a mixture.

### <Component (E)>

The curable resin composition according to the present invention may contain a solvent as a component (E). In particular, the curable resin composition is preferably dissolved or dispersed in the component (E) to be in the form of a varnish.

The component (E) is not particularly limited as long as it dissolves or disperses the curable resin composition according to the present invention, and examples include aromatic compounds such as toluene and xylene; ketone compounds such as methyl ethyl ketone, cyclopentanone, and cyclohexanone; and chlorinated organic solvents such as chloroform.

Of these, aromatic compounds such as toluene and xylene and ketone compounds such as methyl ethyl ketone, cyclopentanone, and cyclohexanone are preferred, aromatic compounds such as toluene and xylene are more preferred, and toluene is particularly suitable.

The component (E) is preferably contained in an amount of 50 to 200 parts by weight, more preferably contained in an amount of 70 to 150 parts by weight, relative to 100 parts by weight of the curable resin composition.

The method of preparing the curable resin composition according to the present invention is not particularly limited, and one example is a method involving mixing the above-described components and mixing or dispersing them with a stirrer.

### <Prepreg>

A prepreg according to the present invention can be a thin-film prepreg of a thermosetting resin composition formed by casting the curable resin composition containing the component (A) and the component (B) and the varnish containing a solvent serving as the component (E) on a support such as a polyimide or polyester film or a glass substrate, followed by drying.

Alternatively, the prepreg according to the present invention can be a prepreg formed by mixing the curable resin composition containing the component (A) and the component (B) and the varnish containing a solvent serving as the component (E) with a reinforcing fiber serving as a component (F). Examples of methods for the mixing include application of the varnish to the reinforcing fiber serving as the component (F) and penetration of the varnish into the reinforcing fiber.

### <Component (F)>

The component (F) in the present invention is not particularly limited as long as it is a reinforcing fiber commonly used for a prepreg. For example, various inorganic fibers and organic fibers such as carbon fiber, aramid fiber, nylon fiber, high-strength polyester fiber, glass fiber, boron fiber, alumina fiber, and silicon nitride fiber can be used. Of these, carbon fiber, aramid fiber, glass fiber, boron fiber, alumina fiber, and silicon nitride fiber may be used from the viewpoint of specific strength and specific modulus. In particular, carbon fiber is preferred from the viewpoint of mechanical properties and weight saving. When carbon fiber is used as the reinforcing fiber, it may be subjected to surface treatment with metal.

The thickness of a fiber substrate is preferably 0.3 mm or less, more preferably 0.15 mm or less, still more preferably 0.1 mm or less.

One component (F) may be used alone, or two or more components (F) may be used in combination.

### <Method for Producing Cured Product>

A cured product according to the present invention can be obtained by curing the curable resin composition according to the present invention.

Examples of methods for producing the cured product according to the present invention include a method in which the prepreg is cured by heating to a predetermined temperature, and a method in which the curable resin composition according to the present invention is cured by heating to a predetermined temperature after, for example, being filled into a mold or the like or being melted by heating and injected into a mold or the like.

The heat-curing temperature can be appropriately determined in the range of 105° C. to 270° C.

### EXAMPLES

The present invention will now be described more specifically with reference to Examples, but it should be noted that the present invention is not limited to these Examples.

The analysis method in the present invention is as follows.

### <Analysis Method>

### (1) Glass Transition Temperature (Tg) and Thermoplasticity

A resin film obtained was measured using the following apparatus under the following conditions, and a glass transition temperature (Tg) was calculated from the improvement of tangent lines drawn by extrapolation before and after the inflection point.
Apparatus: TMA7100 manufactured by Hitachi High-Tech Science Corporation
Sample size: width, 3 mm; length, 20 mm
Conditions: nitrogen atmosphere; load, 200 mN; temperature range, 30° C. to 300° C.; heating rate, 4° C./min
Measurement mode: tensile

### Comparative Example 1

### [Preparation of Prepreg]

One hundred parts by weight of poly(2,6-dimethyl-1,4-phenylene ether) (component (A)), 100 parts by weight of toluene (component (E)), 24.3 parts by weight of 2,2′,3,3′,5,5′-hexamethyl-4,4′-bis(2-propen-1-yloxy)-1,1′-biphenyl (component (B)) serving as a curing agent (hereinafter referred to as “compound B1”), and 0.68 parts by weight of dicumyl peroxide (manufactured by NOF Corporation: trade name “PERCUMYL D”) (component (C), peroxide) serving as a reaction initiator were mixed and stirred with a magnetic stirrer at room temperature to prepare a varnish.

The varnish was applied to a 20-cm square polyimide film (manufactured by UBE Corporation: trade name “UPILEX”) so as to be 0.2 mm thick. Thereafter, from the varnish dried at room temperature to be a semi-cured product, the solvent was removed at 105° C. for 1 hour with a vacuum dryer, thereby obtaining a prepreg of the semi-cured product.

### [Preparation of Resin Film]

An aluminum foil (0.12 mm thick) frame provided with a 9 cm×4 cm opening was sandwiched on both sides by the prepreg, further sandwiched on both sides by two other polyimide films, and sandwiched on both sides by 25 cm×25 cm metal plates. The resultant was then cured by pressing with a vacuum hot-press machine (manufactured by Toyo Seiki Co., Ltd.) under the following temperature, pressure, and time conditions (heating temperature, 105° C.; pressure, 10 MPa; 30 minutes-heating temperature, 150° C.; pressure, 10 MPa; 1 hour-heating temperature, 200° C.; pressure, 10 MPa; 1 hour-heating temperature, 250° C.; pressure, 10 MPa; 1 hour-heating temperature, 270° C.; pressure, 10 MPa; 1 hour). The polyimide film attached to the resulting cured product was removed to obtain a resin film.

The glass transition temperature (Tg) of the resin film obtained was measured by the above-described method to evaluate heat resistance. The result is shown in Table 1.

### Comparative Examples 2 and 3

A prepreg and a resin film were prepared in the same manner as in “Comparative Example 1” above except that the curing agent “compound B1” was used in an amount of 15.0 parts by weight (Comparative Example 2) and 8.0 parts by weight (Comparative Example 3), and the evaluation of heat resistance was performed. The result of the evaluation, that is, the glass transition temperature (Tg), is shown in Table 1.

### Examples 1 to 3

A prepreg and a resin film were prepared in the same manner as in “Comparative Example 1” above except that the curing agent “compound B1” was used in an amount of 4.9 parts by weight (Example 1), 1.6 parts by weight (Example 2), and 0.9 parts by weight (Example 3), and the evaluation of heat resistance was performed. The result of the evaluation, that is, the glass transition temperature (Tg), is shown in Table 1.

### Comparative Example 4

A prepreg and a resin film were prepared in the same manner as in “Comparative Example 1” above except that 3,3′,5,5′-tetramethyl-4,4′-bis(2-propen-1-yloxy)-1,1′-biphenyl (hereinafter referred to as “compound B2”) was substituted for the curing agent “compound B1” and used in an amount of 8.0 parts by weight, and the evaluation of heat resistance was performed. The result of the evaluation, that is, the glass transition temperature (Tg), is shown in Table 1.

### Examples 4 and 5

A prepreg and a resin film were prepared in the same manner as in “Comparative Example 4” above except that the curing agent “compound B2” was used in an amount of 4.1 parts by weight (Example 4) and 1.8 parts by weight (Example 5), and the evaluation of heat resistance was performed. The result of the evaluation, that is, the glass transition temperature (Tg), is shown in Table 1.

### Comparative Examples 5 to 7

A prepreg and a resin film were prepared in the same manner as in “Comparative Example 1” above except that as the curing agent, triallyl isocyanurate (hereinafter referred to as “compound X”) was used in an amount of 7.9 parts by weight (Comparative Example 5), 3.7 parts by weight (Comparative Example 6), and 0.9 parts by weight (Comparative Example 7), and the evaluation of heat resistance was performed. The result of the evaluation, that is, the glass transition temperature (Tg), is shown in Table 1.

TABLE 1

| | Curable resin composition (parts by weight) | | | | | |
|---|---|---|---|---|---|---|
| | | Curing agent | | | Reaction | |
| | | Component (B) | | | initiator | Cured |
| | Component | Compound | Compound | Compound | Component | product |
| | (A) | B1 | B2 | X | (C) | Tg (° C.) |
| Comparative | 100 | 24.3 | — | — | 0.68 | 152 |
| Example 1 | | | | | | |
| Comparative | 100 | 15.0 | — | | 0.68 | 156 |
| Example 2 | | | | | | |
| Comparative | 100 | 8.0 | — | | 0.68 | 174 |
| Example 3 | | | | | | |
| Example 1 | 100 | 4.9 | — | — | 0.68 | 189 |
| Example 2 | 100 | 1.6 | — | — | 0.68 | 202 |
| Example 3 | 100 | 0.9 | — | — | 0.68 | 189 |
| Comparative | 100 | — | 8.0 | — | 0.68 | 164 |
| Example 4 | | | | | | |
| Example 4 | 100 | — | 4.1 | — | 0.68 | 186 |
| Example 5 | 100 | — | 1.8 | — | 0.68 | 198 |
| Comparative | 100 | — | — | 7.9 | 0.68 | 209 |
| Example 5 | | | | | | |
| Comparative | 100 | — | — | 3.7 | 0.68 | 181 |
| Example 6 | | | | | | |
| Comparative | 100 | — | — | 0.9 | 0.68 | 178 |
| Example 7 | | | | | | |

In Examples 1 to 3, which are specific examples of the curable resin composition according to the present invention, the diallyl ether compound having a biphenyl skeleton represented by general formula (1) above (component (B)) is contained in a small amount as a curing agent for curing of polyphenylene ether (component (A)). For example, comparison of Example 3 with Comparative Example 7, in which “compound X” (triallyl isocyanurate) which is a typical curing agent is used in the same amount, in terms of the glass transition temperature (Tg) of cured products shows that the glass transition temperature of Example 3 is higher by 10° C. or more, confirming that a cured product having high heat resistance can be obtained.

It has also been revealed that the effect of the component (B) of the present invention on raising the glass transition temperature (Tg) is equally produced in an amount approximately 1/15 the amount of “compound X” (triallyl isocyanurate), which is a typical curing agent, used.

That is, the curable resin composition according to the present invention produces such an extremely remarkable effect that a cured product having high heat resistance can be obtained even if the component (B) serving as a curing agent is used in a reduced amount.

As shown by the results of Comparative Examples 5 to 7 in Table 1, it has been revealed that as the amount of “compound X” (triallyl isocyanurate), which is a typical curing agent, used increases, the glass transition temperature (Tg) of the cured product tends to increase, whereas the effect of the component (B) of the present invention on raising the glass transition temperature (Tg) peaks in the range of the amount used in the present invention, confirming that this tendency is very different from that of the typical curing agent (compound X: triallyl isocyanurate) whose amount used and effect on raising the glass transition temperature (Tg) are proportional to each other.

That is, it has been revealed that the curable resin composition according to the present invention, in a range where the diallyl ether compound having a biphenyl skeleton represented by general formula (1) above (component (B)) is added in a small amount in a specific range, produces an extremely excellent effect of raising the glass transition temperature (Tg) and provides remarkable heat resistance as compared with the typical curing agent.

This effect enables a significant reduction in the cost of the curing agent in the production of a processed product using a polyphenylene ether resin, which is industrially very useful. Furthermore, the problem of apparatus contamination due to volatilization of the curing agent can be reduced, which is very advantageous also in terms of yield and production efficiency.

In addition, in a resin composition containing a polyphenylene ether resin, the content ratio of the polyphenylene ether resin whose dielectric constant and dielectric loss tangent are low can be increased, and thus when the resin composition is used as, for example, a substrate material for a printed wiring board, it is expected that a printed wiring board having excellent electrical properties can be obtained.

1. A curable resin composition comprising a component (A) below in an amount of 100 parts by weight and a component (B) below in an amount of 0.1 to 4.9 parts by weight:
(A): a polyphenylene ether resin,
(B): a diallyl ether compound represented by general formula (1) below: 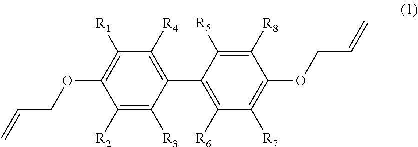
wherein R₁ to R₈ each independently represent a hydrogen atom or an alkyl group having 1 to 5 carbon atoms.

2. The curable resin composition according to claim 1, wherein the component (B) is at least one selected from 4,4′-bis(2-propen-1-yloxy)-1,1′-biphenyl, 3,3′-dimethyl-4,4′-bis(2-propen-1-yloxy)-1,1′-biphenyl, 3,3′,5,5′-tetramethyl-4,4′-bis(2-propen-1-yloxy)-1,1′-biphenyl, and 2,2′,3,3′,5,5′-hexamethyl-4,4′-bis(2-propen-1-yloxy)-1,1′-biphenyl.

3. The curable resin composition according to claim 1, further comprising a component (C) below in an amount of 0.05 to 1.0 parts by weight:
(C): a reaction initiator.

4. The curable resin composition according to claim 3, wherein the component (C) is an organic peroxide.

5. The curable resin composition according to claim 4, wherein the component (B) is at least one selected from 4,4′-bis(2-propen-1-yloxy)-1,1′-biphenyl, 3,3′-dimethyl-4,4′-bis(2-propen-1-yloxy)-1,1′-biphenyl, 3,3′,5,5′-tetramethyl-4,4′-bis(2-propen-1-yloxy)-1,1′-biphenyl, and 2,2′,3,3′,5,5′-hexamethyl-4,4′-bis(2-propen-1-yloxy)-1,1′-biphenyl.

6. A cured product comprising a cured composition obtained by curing the curable resin composition according to claim 1.

7. The curable resin composition according to claim 1, further comprising a component (D) below:
(D): a filler.

8. A cured product comprising a cured composition obtained by curing the curable resin composition according to claim 7.

9. A varnish comprising the curable resin composition according to claim 1 and a component (E) below:
(E): a solvent.

10. A prepreg comprising the varnish according to claim 9 and a component (F) below:
(F): a reinforcing fiber.

11. A cured product comprising a cured composition obtained by curing the prepreg according to claim 10.

12. The curable resin composition according to claim 1, which consists of the component (A) and the component (B) wherein an amount of the component (A) and the component (B) in total is 100.1 to 104.9 parts by weight.

13. The curable resin composition according to claim 3, which consists of the component (A), the component (B), and the component (C) wherein an amount of the component (A), the component (B), and the component (C) in total is 100.15 to 105.9 parts by weight.

14. The curable resin composition according to claim 1, wherein, in the formula, R₁ to R₈ each independently represent a linear alkyl group having 2 to 5 carbon atoms or a branched alkyl group having 3 to 5 carbon atoms.
